(19) United States
(12) Patent Application Publication
(10) Pub. No.: US 2008/0251184 A1
(43) Pub. Date: Oct. 16, 2008

(54) ACCOMPANYING WINDING SPACER AND METHOD FOR MANUFACTURING STRIP TYPE MATERIALS USING THE SAME

(76) Inventor: Li-Hua Wang, Taipei City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/733,971

(22) Filed: Apr. 11, 2007

(51) Int. Cl. B32B 33/00

(52) U.S. Cl. 156/90; 428/323

(57) ABSTRACT

An accompanying winding spacer is used to evolve volatile materials and by-products contained in a strip laminate. The strip laminate and the spacer are wounded in a roll state together and treated by heat or radiation to evolve the volatile materials and by-products. The spacer comprises a smooth surface (Rz<1 mm) and a surface including a raised coarse portion at each longitudinal edge thereof. When the strip laminate and the spacer according to the present invention are wound in a roll state together and treated by heat or radiation, the volatile materials and by-products is evolved out of the laminate from passages formed by the recess portions of the coarse portions at both edges of the spacer.

### BACKGROUND OF THE INVENTION

1. Field of the Invention

The present invention relates to an apparatus and a method for removing volatile substances contained in materials, and in particular to an apparatus and a method for removing by-products such as volatile solvents and/or gases when manufacturing a laminate for flexible printed circuit boards.

2. The Prior Arts

The conventional methods for removing volatile solvents and gaseous by-products contained in a strip laminate are heat-treating or heat-treating with decompression (e.g. vacuuming). They remove the volatile solvents and/or gaseous by-products, dry the material, and effectively accelerate the chemical reactions including polymerization. For example, a polyamic acid (PAA) varnish containing one or more than one volatile solvents is coated on a surface of copper foil while manufacturing copper clad laminate for the flexible printed circuit board. In the next stage, i.e. the curing stage, the one or more than one volatile solvents used to dissolve the polyamic acid (PAA) and by-products including water are removed, and the polyamic acid is polymerized into polyimide (PI) by heat or radiations such as ultraviolet or infrared. Such curing process can be performed by either continuous or batch type processes. In continuous process cases, longer curing times always causes longer curing ovens, which cause high facility and operation costs and raise serious controlling and operating difficulties.

In order to solve this problem, a prior art discloses a heating method of winding the strip laminate in a roll state and heat-treating the strip laminate. The method does not utilize any accompanying winding spacer and hence it results in a sticking problem between layers of the rolled strip laminate. To solve this material-sticking problem, Japanese Patent Publication No. 4-84488 discloses a heating method of utilizing an accompanying winding spacer made of non-woven fabric or a stainless steel mesh having a surface roughness (Ra) greater than 0.5 μm. The practical application of the method is not sufficient neither for problems such as fiber sticking of non-woven fabric as well as transfer of a pattern (e.g. the fiber and mesh patterns) on the surface of the processed material. Another Japan Patent Publication No. 8-224797 discloses an accompanying winding spacer 10 made of a copper foil, which has a rough surface comprising a plurality of protrusions 12 on one side, and a smooth surface on the other side (as shown in FIG. 1). The rough surface of the spacer is pressed against the monomer-coated surface of the strip laminate. The spacer and strip laminate are then wound into a roll. When the spacer and the strip laminate are heat-treated, the volatile solvent is vaporized and evolved from gaps between the protrusions 12. This method could prevent a fiber from sticking on the surface of the processed material and reduce transfer of a pattern on the surface of the processed material. However, it still can't avoid the pattern transfer issues completely. Additionally, not only the production cost of the spacer is high, but also the retirement of the spacer is frequent because remaining monomers or by-products would jam the gaps on the rough surface of the spacer shortly.

In order to completely solve the pattern transfer problem of the conventional heating methods, another heating method discloses a spacer made of a metal mesh strip. The spacer is disposed at each of the two longitudinal edges of the strip laminate, then the strip laminate and the spacers are wound into a roll state, and the strip laminate and the spacers are then cured together. After the curing process, both longitudinal edges of the strip laminate with transfer patterns are cut off. Thus a finished product does not have any pattern. Only that the practical application of this method still has some disadvantages. For instance, while the metal mesh strips are wound with the strip laminate into a roll, unwinding the rolled metal mesh strips generates a friction force. The friction forces of the metal mesh strips produce different operation tensions and unwound speeds. Thus, metal mesh strips apply different forces at both edges of the strip laminate and make it wrinkle. Additionally, if the metal mesh strips are too thick, the standing-up roll of strip laminate cannot support the weight of the metal mesh strips and will buckle. Therefore, the surface of the strip laminate has wrinkles and a damaged appearance. On the other hand, if the metal mesh strip is too thin, the rolled strip laminate will be stuck together. The metal mesh strip may also loses its function because Hot air cannot pass through the gaps on the metal mesh strip either due to the ratio of a ventilating length to the gap width is too large. It also causes the differences in both the physical and chemical characteristics at inner/outer layers of the rolled strip laminate. Moreover, this problem can't even be solved by a radiation heat treatment.

### SUMMARY OF THE INVENTION

In order to overcome the disadvantages of the conventional heating methods, the present invention provides a method utilizing a spacer to evolve a volatile substance contained in a material. The method overcomes the disadvantages of the aforementioned conventional heating methods, of which the unwanted residues (such as, fibers), patterns and wrinkles, are left on the surface of the strip laminate material, and both the physical and chemical characteristics at the inner/outer layers of the rolled strip laminate are changed (e.g. uneven surface colors).

In order to achieve the objective of the present invention, a spacer according to the present invention is used to evolve the volatile material contained in a strip laminate. The strip laminate and the spacer are wound up into a roll state together and heat-treated to evolve the volatile material. The spacer has a smooth surface on one side, and a surface having a raised coarse portion at each of the two longitudinal edges on the reverse side. The coarse portions comprise a plurality of recess portions as gas passages.

The strip laminate and the spacer according to the present invention are wound into a roll state together. The volatile material evolves from the strip laminate via the recess portions in the coarse portions at longitude edges of the spacer when the strip laminate is heat-treated.

A method for manufacturing a laminate for printed circuit boards by using an accompanying winding spacer according to the present invention comprising the steps of: (1) providing a strip laminate comprising a substrate and a material layer that is coated on the substrate and contains volatile materials; (2) stacking and winding the strip laminate and a spacer in a roll state, wherein the spacer separates every layer of the rolled strip laminate, and a surface of the spacer having coarse portions is pressed against the material layer of the strip laminate; and (3) heat-treating the roll of the strip laminate and the spacer to evolve the volatile material from recess portions of the coarse portions at both edges of the spacer.

The accompanying winding spacer in accordance with the present invention effectively prevents the strip laminate from wrinkling due to unbalanced tensions at both edges thereof. Additionally, the spacer of the present invention may be made of a thermal conductive material to increase the heat-dissipation cross-section area (i.e. thickness of the strip laminate with the spacer is larger than that of the strip laminate alone). Thus it minimizes the temperature difference between inner and outer layers of the rolled strip laminate, and prevents the inner and outer layers of the strip laminate from having different physical and chemical characteristics due to temperature differences. Moreover, the spacer according to the present invention effectively enhances the strength of the rolled strip laminate, and prevents the standing-up rolled strip laminate from buckling due to overweight of the spacer located at the upper edge. Therefore, the spacer according to the present invention makes it possible to manufacture an extra-thin strip laminate.

The strip material utilized in the present invention is a thin-layer material whose length-to-width ratio is greater than 10. The strip laminate utilized in the present invention is a stacked composite composed of a plurality of the strip materials.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view showing a conventional accompanying winding spacer, wherein (A) is a top view and (B) is a cross-sectional view taken along the line B-B in FIG. 1A; and

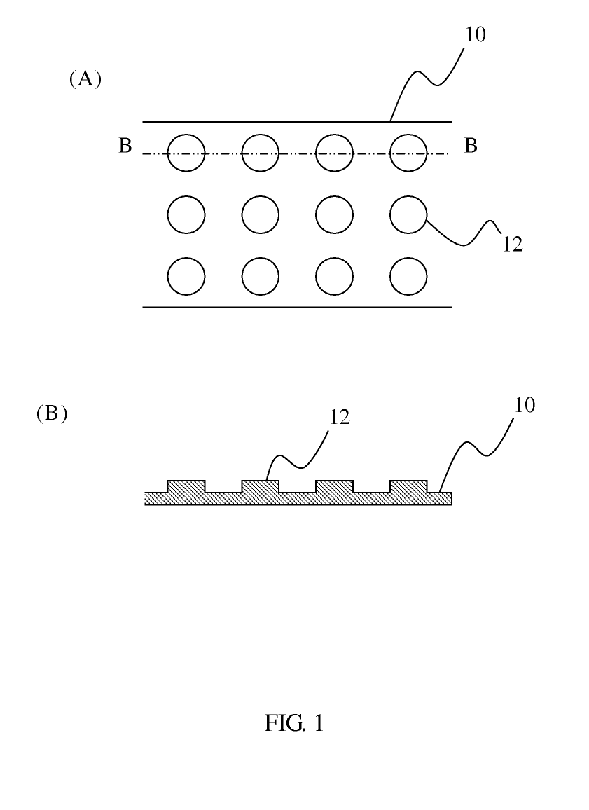

FIG. 2 is a schematic view showing an accompanying winding spacer in accordance with the present invention, wherein (A) is a top view, and (B) is a cross-sectional view taken along the line B-B in FIG. 2A.

### DETAILED DESCRIPTION OF THE PREFERRED EMBODIMENT

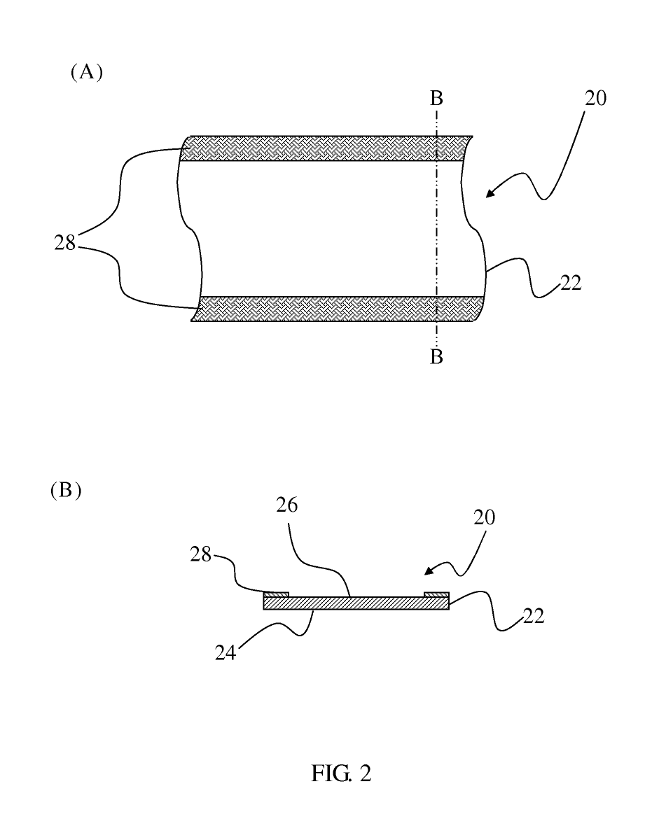

With reference to FIG. 2, an accompanying winding spacer 20 in accordance with the present invention is used to evolve volatile materials contained in a strip laminate. The strip laminate and the spacer 20 are wound in a roll state and heat-treated to remove the volatile materials. The spacer 20 comprises a supporting board 22 having a smooth first surface 24 and a second surface 26 at the reverse side of the first surface 24. The second surface 26 has a raised coarse portion 28 at each longitudinal edge thereof. The coarse portion 28 is an integral part or a separated part of the second surface 26 of the spacer 20. Considering the cost as well as replaceablility of parts, the separated coarse portion 28 is preferred.

When the coarse portions 28 and the supporting board 22 is an integral part of the spacer 20, the coarse portion 28 according to the present invention is a structure with continuous recess portions. There is no particular limitation for the structure. The present invention could use any conventional structure that does not block the flowing of the volatile gas and allows the heated vaporized volatile material to pass through the continuous recess portions and evolve from edges of the rolled strip laminate. For example, the aforementioned structure with continuous recess portions is a plane that comprises a plurality of protrusions. The protrusions include cylinders, oval pillars, horseshoe pillars, rectangular pillars, and trapezoid pillars. The protrusions are manufactured by mechanical or chemical processes, such as machining, etching, etc.

In the cases that the coarse portions 28 and the supporting board 22 are separated parts of the spacer 20, the coarse portion 28 according to the present invention is a strip structure with continuous recess portions, such as a mesh strip. There is no particular limitation for the structure. The thickness of the coarse portion 28 according to the present invention does not have particular limitation either, as long as it is thick enough to evolve vapor through the recess portions. However, the preferred thickness is between 15 and 100 μm.

The supporting board 22 of the spacer 20 is made of a material the same as or different from that of the coarse portion 28. Moreover, any material showing good high temperature resistance is applicable to the present invention. Considering both the thermal-conduction and supporting factors for the rolled strip laminate, the supporting board 22 prefers copper foil, aluminum foil, stainless steel foil, or a laminate coated with the aforementioned metal foil. There is no particular limitation for the thickness of the supporting board 22 in accordance with the present invention. However, for an effective supporting, the total thickness for both the supporting board 22 and the strip laminate prefers to be between 30 and 3000 μm. Therefore, the present invention is applicable to an extra-thin strip laminate (e.g. 9 μm copper-clad laminate).

The strip laminate utilizing the accompanying winding spacer 20 in accordance with the present invention can be a strip laminate, which has a heat-resistant resin film coated on a metal foil. The resin film contains volatile materials, which is evolved by heat or radiation treatment. The strip laminate according to the present invention can be copper clad laminates or aluminum clad laminates coated with polymers such as polyethylene, polypropylene, polyester, polyamide, polyimide, or polystyrene, or their combinations. However, the strip laminates are not limited by the samples mentioned above.

The smooth first surface 24 of the spacer 20 according to the present invention is a plane having a substantial smooth surface, even thought it has small-scale variations in the height of a physical surface. The smooth surface 24 mentioned above especially means that has an average roughness depth Rz smaller than 1 mm. Furthermore, the recess portions of the coarse portions 28 on the spacer 20 according to the present invention may have different sizes, or uneven distribution, as long as they do not affect the volatile material evolved from the recess portions.

The strip laminate containing volatile materials mentioned in the present invention comprises a plurality of metal foils separated and supported by material layers. The material layers are made of a single material or a variety of materials. The metal foil, such as a copper foil, used in the strip laminate can be coated with polyimide resin precursor solution as a base substrate and then coated with a photosensitive resin solution.

The accompanying winding spacer 20 according to the present invention is used to manufacture the laminates for the printed circuit board. The laminates for the printed circuit board comprises conductive layers composed of metal foils (e.g. copper foils) and insulating layers, which are a resin solution (e.g. polyimide resin precursor) coated on the metal foils. Each of the laminate can be pre-dried and then wound into a roll state together with the spacer 20 in accordance with the present invention. When winding the laminate with the spacer 20, the smooth first surface 24 of the spacer 20 according to the present invention faces toward the conductive layer of the laminate and the second surface 26 faces toward the insulating layer. The solvents and by-products remained in polyimide resin precursor will be vaporized and evolved when the rolled laminate is cured. In the mean time of heat-treatment, the ring-closing reaction makes the precursor transformed into polyimide. The water and other by-products produced from the reaction and the unreactive remaining monomer (gaseous by-product) are also vaporized and evolved.

The heated vaporized volatile materials pass through the passages formed by the recess portions of the coarse portions 28 located at both longitudinal edges of the spacer 20 and evolves from the inside of the rolled laminate. Therefore, it prevents volatile materials from accumulating inside and between the rolled laminate layers, and thus it prevents the contamination from the surface of the finished product. The smooth surface 24 of the spacer 20 contacts with the conductive layer, so it prevents poor appearance of the laminate. In addition, the spacer 20 according to the present invention enlarges the cross-section area for the rolled laminate, and thus it strengthens the stand-up rolled laminate. Because the spacer 20 according to the present invention increases the conductive cross-sectional area, it also enhances the thermal conductive efficiency. Therefore, the temperature difference between the inner and outer layers of the rolled laminate is minimized. It prevents the inner and outer layers of the laminate from having different physical and chemical characteristics (e.g. uneven surface colors) due to different heating temperatures at the inner/outer layers of the rolled laminate.

In addition, the smooth first surface 24 of the spacer 20 according to the present invention is pressed against the conductive layer of the laminate, and thus it increases the cross-section area of the load-bearing laminate. Even if the conventional metal mesh strips are used as the coarse portions 28 of the spacer 20, and the metal mesh strips have different tensions and unwound speeds at both longitudinal edges of the spacer 20, the increased cross-section area makes the spacer 20 less sensitive to the different tensions at the both edges. Therefore, it is less likely to have wrinkles on the laminate.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An accompanying winding spacer used for evolving a volatile material contained in a strip laminate, comprising
a smooth first surface at one side; and
a second surface at the reverse side of the first surface having a raised coarse portion at each longitudinal edge thereof;
wherein the spacer and the strip laminate are wound in a roll state together and treated by heat or radiation to evolve volatile materials and by-products.

2. The spacer as claimed in claim 1, wherein the coarse portions and the second surface of the spacer are an integral part.

3. The spacer as claimed in claim 2, wherein the coarse portion is a structure having continuous recess portions.

4. The spacer as claimed in claim 3, wherein the coarse portion comprises a plurality of protrusions that are protruded from the second surface.

5. The spacer as claimed in claim 1, wherein the coarse portions and the second surface of the spacer are separated parts.

6. The spacer as claimed in claim 5, wherein the coarse portion is a strip structure having continuous recess portions.

7. The spacer as claimed in claim 6, wherein the strip structure is one of a metal strip and a metal mesh strip.

8. The spacer as claimed in claim 1, wherein a total thickness of the spacer and the strip laminate is between 30 and 3000 μm.

9. The spacer as claimed in claim 1, wherein the smooth first surface of the spacer is pressed against a side of the strip laminate that does not contain volatile material and the second surface of the spacer having the coarse portions is pressed against the other side of the strip laminate that contains the volatile materials when the spacer and the strip laminate are wound in the roll state together.

10. The spacer as claimed in claim 1, wherein the thickness of the coarse portion is between 15 and 100 μm.

11. The spacer as claimed in claim 1, wherein the average roughness depth (Rz) of the smooth first surface is less than 1 mm.

12. A method of using an accompanying winding spacer for manufacturing a laminate of printed circuit board, comprising the steps of:
(1) providing a strip laminate comprising a substrate and a material layer that is coated on the substrate and contains volatile material;
(2) stacking and winding the strip laminate and the spacer as claimed in claim 1 in a roll state, wherein the spacer separates every layer of the rolled strip laminate, and a surface of the spacer having coarse portions is pressed against the layer of the strip laminate containing the volatile materials and by-products; and
(3) treating the roll of the strip laminate and the spacer by heat or radiation to evolve the volatile material from recess portions of the coarse portions at both edges of the spacer.
